(19) United States
(12) Patent Application Publication
(10) Pub. No.: US 2008/0262283 A1
(43) Pub. Date: Oct. 23, 2008

(54) Process for the removal of hydrocarbons from soils

(76) Inventor: Bill Rippetoe, Dallas, TX (US)

Correspondence Address: BILL RIPPETOE, SUITE 411, 14114 DALLAS PARKWAY, DALLAS, TX, 75254, US

(21) Appl. No.: 11/789,067

(22) Filed: Apr. 23, 2007

(51) Int. Cl. A62D 3/10

(52) U.S. Cl. 588/301

(57) ABSTRACT

A method of removing hydrocarbons from soils contaminated with various hydrocarbons such as gasoline, diesel fuel, solvents, motor oil and crude oil. The process first screens the soil to remove oversized rocks and debris and to reduce the contaminated soil to uniformly sized particles. The soil particles are moved along a conveyor and first sprayed with an oxidizer diluted with ionized water and then sprayed with ionized/oxidized water. The washed particles are then vigorously mixed with an auger mixer for several minutes to oxidize almost all of the remaining hydrocarbons. The washed and hydrocarbon-free soil is then moved by conveyor to a stockpile for storage, testing and drying.

### FIELD OF THE INVENTION

Our invention lies in the field of remediating contaminated soils and more particularly to the removal of accidentally or intentionally deposited oil and other hydrocarbons from various types of soil.

### BACKGROUND OF THE INVENTION

In the past and at present, there are three methods for treating hydrocarbon contaminated soils, namely, incineration, bioremediation and soil washing. Incineration has the inherent cost disadvantages of high energy costs and transporting the soil to and from a usually remote incinerator. Bioremediation has the inherent disadvantages of low throughput, sensitivity to changes in temperature, uneven results and the extended period of time required to complete remediation. Most common soil washing techniques use surfactants to float out the hydrocarbons into the wash water requiring costly continuous water treatment to extract the hydrocarbons from the aqueous phase and have difficulty in reducing contamination to regulatory limits. Conventional soil washing, if it works, has a limited production volume.

Due to the high cost of cleaning contaminated soil, there exists throughout the United States millions of tons of soil contaminated with hydrocarbons located within such installations as oil refineries, industrial plants, airports, motor vehicle repair shops, auto service stations and military training areas.

Accordingly, there is a need for a high volume low cost method of efficiently removing hydrocarbons from contaminated soils.

There is also a need for a method of removing hydrocarbons from contaminated soils with portable equipment that can be moved from one contaminated site to another.

### SUMMARY OF THE INVENTION

Our invention involves the use of at least one Ion Collider™ as shown and described in U.S. Pat. No. 5,482,629 issued Jan. 9, 1996 and U.S. Pat. No. 6,106,787 issued Aug. 22, 2000. As taught in our patents, water pumped through an Ion Collider ionizes the water and alters its physical characteristics. All embodiments of our invention use Ion Collier treated water and the use of surfactants is totally eliminated.

Soils contaminated with spilled or otherwise deposited hydrocarbons in the range of C.sub.8 to C.sub.40, such as diesel fuel, gasoline, jet fuel motor oil, cutting oils and crude oil, are first passed through a screening process to eliminate oversized rocks and debris and to reduce the soil to uniformly sized particles. The resulting particles are sprayed with an oxidizer diluted with Ion Collier treated water and then vigorously mixed in an auger mixer for several minutes with the entrained oxidizer and Ion Collider treated water. This vigorous mixing of the soil particles, the oxidizer and the Ion Collider treated water oxidizes the hydrocarbons, leaving the washed soil with minimal hydrocarbons well below regulatory limits. Neither Ion Collider treated water, its spraying nor the oxidizing process itself creates prohibited products. Our method is environmentally safe.

In the case of soils contaminated with crude or other heavy oils, we may increase the volume or strength of the oxidizer and/or increase the time of vigorous mixing of the soil, the oxidizer and the ionized water to produce washed soils whose hydrocarbon content are well below regulatory limits.

### BRIEF DESCRIPTION OF THE DRAWINGS

FIG. 1 is a flow diagram of a preferred embodiment of our invention for treating soils contaminated with various types of hydrocarbons.

FIG. 2 illustrates the actual equipment we have used to treat soil contaminated with spilled gasoline, diesel fuel, jet fuel, motor oils and various other hydrocarbons.

### DETAILED DESCRIPTION OF THE PREFERRED EMBODIMENT

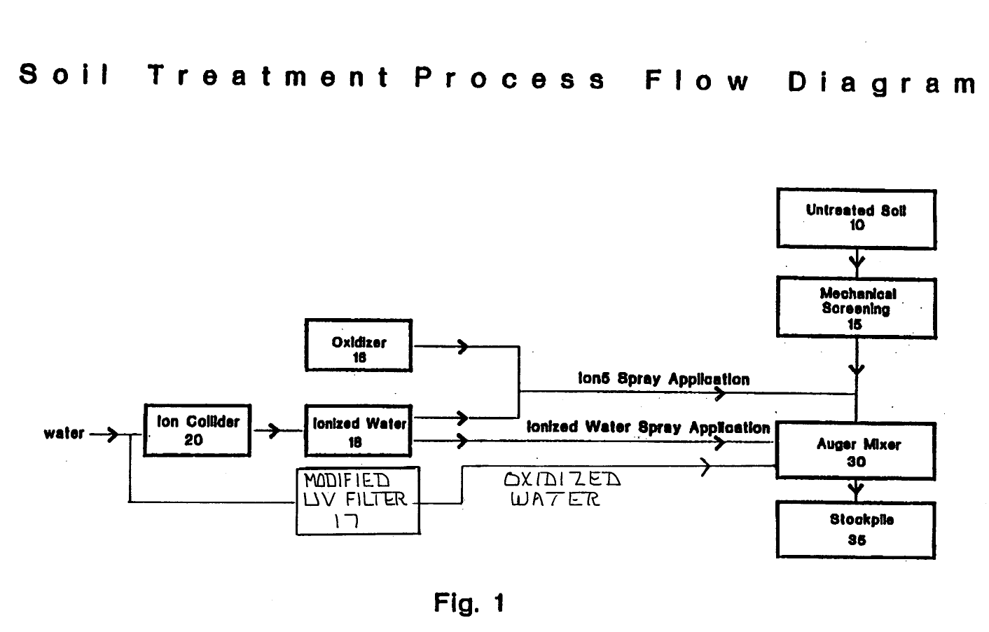

FIG. 1 is a flow diagram of the method used at the Miami International Airport in Dade County, Fla. for cleaning soils contaminated with spilled or deposited gasoline, diesel fuel, motor oil, hydraulic fluid and other hydrocarbons.

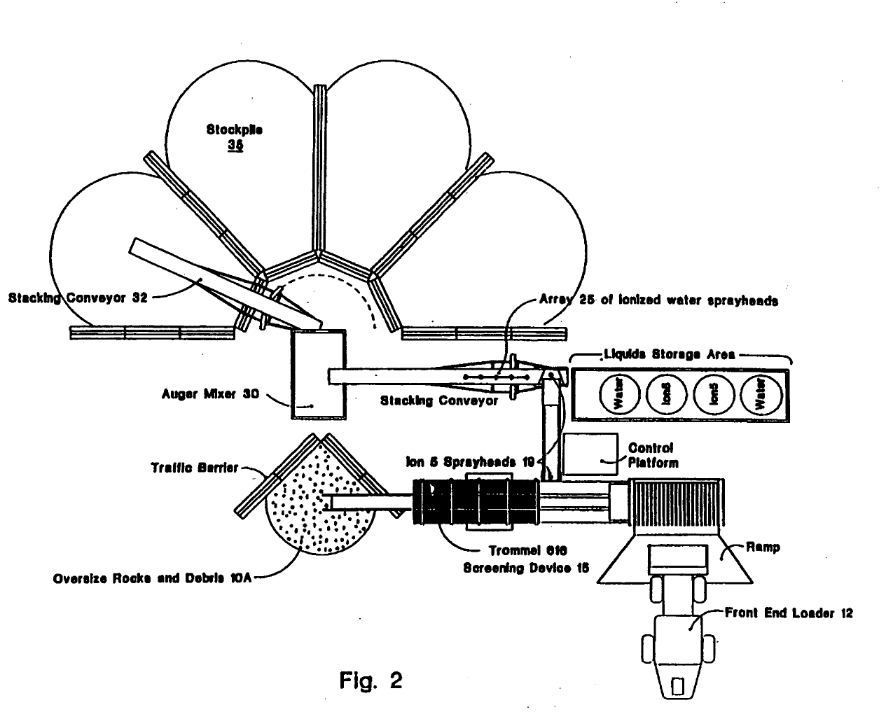

FIG. 2. is a plan view of the actual equipment used to carry out our method of cleaning soils shown in FIG. 1.

Contaminated and untreated soil 10 is transported preferably by front end loaders 12 to a mechanical screening device 15 such as a Trommel™ 616 to reduce the soil to uniformly sized particles from which oversized rocks and debris 10A are removed and discarded as shown in FIG. 2.

The soil particles resulting from the screening process are sprayed with an oxidizer 16 such as titanium oxide diluted to a concentration of between 275 to 1000 milligrams of oxidizer to a liter of ionized water 18, that is, water which has been passed through an Ion Collider 20 and thereby electrically charged, i.e. ionized. Two sprayheads 19 spraying oxidizer 16 diluted with ionized water 18 are shown in FIG. 2.

Additionally, oxidized water which has been passed through a modified ultraviolet filter 17 is photochemically excited and sent to sprayheads 19. Photochemically-excited semiconductor particles can catalyze the reduction and/or oxidation of a variety of chemical species. Charge-pair generation is achieved by the absorption of a proton with an energy greater than or equal to its band gap energy. The absorbed photon promotes an electron from the valence band into the conduction band, and in doing so, creates a positively charged valence band hole.

Excited-state electrons and holes can either recombine with the release of heat or migrate through the lattice structure to various trapped sites or migrate to the particle surface and participate in electron transfer reactions.

For wastewater remediation titanium oxide offers great potential as an industrial technology for detoxification or remediation of wastewater due to several factors such as working under ambient conditions. Titanium dioxide is a well-known photocatalyst for water and air treatment as well as for catalytic production of gases. The general scheme for the photocatalytic destruction of organics begins with its excitation by suprabandgap photons, and continues through redox reactions where OH radicals, formed on the photocatalyst surface, play a major role.

A modified ultraviolet inline filter will be produced by coating the clear tubing contained within a commercially available UV light filter and surrounding the UV light with a titanium oxide coating. As the un-treated water passes through the UV filter the water is charged to the point that hydroxyl radicals are formed from the oxidation of un-treated water. Bound hydroxyl groups are generally believed to be the principal reactive species responsible for the photo oxidation of organic compounds in semiconductor photocatalysis.

It has been known for some time that titanium dioxide can achieve photodechlorination of PCB's, by ultra violet light with a wavelength of 365 nm of a 25 ppb aqueous solution in the presence of suspended particulate titanium dioxide After 30 min. Titanium dioxide is also known for breaking water into hydrogen and oxygen.

The two storage tanks marked Ion 5 in the liquids storage area shown in FIG. 2 are filled with oxidizer 16 diluted with ionized water and the two storage tanks marked water contain ionized water used in our unique method of removing hydrocarbons from soils.

The two water tanks may additionally be coated with titanium oxide. Recently it has been found that titanium dioxide, when spiked with nitrogen ions, is also a photocatalyst under visible light. The strong oxidative potential of the positive holes oxidizes water to create hydroxyl radical. It can also oxidize oxygen or organic materials directly.

Following being sprayed with an oxidizer diluted with ionized water from Ion 5 sprayheads 19, the soil particles as they are moved along a conveyor are sprayed with ionized water 18 and oxidized water 19 from an array 25 of spray nozzles as shown in FIG. 2. The washed soil particles are then vigorously mixed for several minutes with the entrained oxidizer and ionized water in an Eagle™ 24 auger mixer 30 as shown in both FIGS. 1 and 2. The process oxidizes the remaining hydrocarbons, leaving the washed soil almost totally free of hydrocarbons.

The washed and hydrocarbon-free soil is fed from the auger mixer 30 along a stacking conveyor 32 to be stored until testing is completed in one of a series of stockpiles 35 as shown in FIG. 2.

Although the present invention has been described in conjunction with preferred embodiments, it is to be understood that modifications and variations may be substituted without departing from the spirit and scope of the invention as those skilled in the art will readily understand. Such modifications and variations are considered to be within the purview and scope of the invention and the appended claims.

We claim:

1. A method of removing hydrocarbons from soils contaminated with deposited hydrocarbons comprising
removing oversized rocks and debris and converting the remaining contaminated soil into uniformly sized particles,
spraying the soil particles with ionized water treated with a Ion Collider and oxidized water treated with a modified ultraviolet filter,
vigorously mixing the sprayed soil particles with its entrained oxidizer and ionized/oxidized water in an auger mixer for several minutes thereby oxidizing almost all of the hydrocarbons remaining in the soil, and
removing the washed and hydrocarbon-free soil particles from the auger mixer to be stored, tested and dried.

2. A method of removing hydrocarbons from soils contaminated with deposited hydrocarbons as set forth in claim 1 in which the soil particles are sprayed with ionized/oxidized water following their being sprayed with an oxidizer diluted with ionized water but before the particles are vigorously mixed with entrained oxidizer and ionized water in an auger mixer.

3. A method of removing hydrocarbons from soils contaminated with deposited hydrocarbons as set forth in claim 1 in which the oxidizer is titanium oxide diluted to a concentration of from 275 to 1,000 milligrams of titanium oxide to one liter of ionized water.

4. A method of removing hydrocarbons from soils contaminated with deposited hydrocarbons as set forth in claim 1 in which the titanium oxide solution is irradiated with a non-ultraviolet light source during the remediation process.

5. A method of removing hydrocarbons from soils contaminated with deposited hydrocarbons as set forth in claim 1 in which the a titanium oxide dry powder is mixed with the contaminated soil and irradiated with an ultraviolet light source during the remediation process.

6. A method of removing hydrocarbons from soils contaminated with deposited hydrocarbons as set forth in claim 1 in which the titanium oxide is in slurry form and mixed with contaminated soil.

7. A method of removing hydrocarbons from soils contaminated with deposited hydrocarbons as set forth in claim 1 in which the titanium oxide coated screen is used for separation of particles in the remediation process.

8. A method of removing hydrocarbons from soils contaminated with deposited hydrocarbons as set forth in claim 1 in which a porous substrate having a photoreactive metal semiconductor material bonded with, to or into surfaces of said substrate, said substrate comprising a filamentous, fibrous or stranded base material through which the contaminated soil can flow in intimate contact with the photoreactive material.

9. A method of removing hydrocarbons from soils contaminated with deposited hydrocarbons as set forth in claim 1 in which a substrate is at least partially transparent to light at a wavelength to which the semiconductor material photoreacts.

10. A method of removing hydrocarbons from soils contaminated with deposited hydrocarbons as set forth in claim 1 in which the titanium oxide is in a hydrosol solution.

11. A method of removing hydrocarbons from soils contaminated with deposited hydrocarbons as set forth in claim 1 in which the conveyor belt is made with a titanium oxide coating.

12. A method of removing hydrocarbons from soils contaminated with deposited hydrocarbons as set forth in claim 1 in which the water storage tanks are a semi clear plastic tank coated with titanium oxide.

13. A method of removing hydrocarbons from soils contaminated with deposited hydrocarbons comprising
removing oversized rocks and debris and converting the remaining contaminated soil into uniformly sized particles,
spraying the soil particles with an oxidizer comprised of a titanium oxide diluted with ionized water,
Subjecting the titanium oxide solution to a light source,
vigorously mixing the sprayed soil particles with its entrained oxidizer and ionized water in an auger mixer for several minutes thereby oxidizing almost all of the hydrocarbons remaining in the soil, and
removing the washed and hydrocarbon-free soil particles from the auger mixer to be stored, tested and dried.

14. A method of removing hydrocarbons from soils contaminated with deposited hydrocarbons as set forth in claim 13 in which the titanium oxide solution to a exposed to a ultraviolet light source,
